(19) United States
(12) Patent Application Publication
(10) Pub. No.: US 2007/0294192 A1
(43) Pub. Date: Dec. 20, 2007

(54) SYSTEMS AND METHODS FOR PRICE SETTING AND TRIANGULATION

(76) Inventor: Jens E. Tellefsen, Mountain View, CA (US)

Correspondence Address: KANG LIM, 3494 CAMINO TASSAJARA ROAD #436, DANVILLE, CA, 94306, US

(21) Appl. No.: 11/748,957

(22) Filed: May 15, 2007

Related U.S. Application Data
(60) Provisional application No. 60/800,640, filed on May 15, 2006.
(60) Provisional application No. 60/825,902, filed on Sep. 16, 2006.

(51) Int. Cl. G06Q 10/00; G06F 17/00

(52) U.S. Cl. 705/400

(57) ABSTRACT

The present invention relates to a unified, user driven, business-to-business pricing tool covering all price setting processes. The pricing tool utilizes a multi-dimensional, multi-level workbook which allows the user to select and edit chosen parameters at any level or dimension. The pricing tool allows edited parameters to be set at a high level and inherited throughout the workbook. Optimization and analytical tools may then be used throughout the workbook whereby the edited parameters are incorporated into the optimization and analysis. A price triangulation module is included whereby preferred business segmentation and selected business pricing goals and constraints may be incorporated into the optimization at any said level or dimension.

### PRIORITY AND INCORPORATION BY REFERENCE

This application claims priority of U.S. Provisional Patent Applications No. 60/800,640, filed May 15, 2006 and No. 60/825,902, filed Sep. 16, 2006, which are hereby fully incorporated by reference.

### BACKGROUND OF THE INVENTION

The present invention relates to business-to-business price setting and management systems. More particularly, the present invention relates to systems and methods for providing a robust, interactive, user-friendly price setting tool.

Many businesses rely upon careful pricing in order to stay competitive and still realize a profit. Successful price setting may be the difference between a company's solvency and demise. Through proper pricing, market dominance may be obtained and held, even in very competitive markets.

Setting an optimal price for a product and market segment is very challenging as it needs to address several drivers and constraints, including: historical negotiated prices, win ratios at different price points, competitive prices, minimum price constraint, etc.

Price setting professionals are often forced to pick one primary driver (e.g. historical prices) to set price as they lack a comprehensive solution that can incorporate multiple data points into the price setting process.

The price setting process needs to output multiple price points, including list price, negotiated target price, approval price levels, and price floors.

Additionally, each market segment (e.g. geography, industry or company size or type) can have its own set of prices or price adjustments.

The complexity of addressing multiple price drivers, price points and segments across thousands of products requires a large diversion of time and man-hours of officials within a company. The loss in productivity due to price setting is often enormous. Most companies cannot invest adequate amount of time to the price setting process resulting sub-optimal prices which in turn leads to lower profits and shareholder value.

Traditionally, teams of marketing specialists, or the truly gifted businessperson, were needed to devise successful pricing schemes. Often such pricing suggestions were not competitive and too costly to generate.

With the advent of computers, automated pricing became a reality. However, such pricing schemes often did not have the desired level of utility, intuitiveness, and functionality as to be of any great improvement over more traditional methods of price setting. Furthermore, such automated price setting systems were unable to incorporate multiple drivers (or data points) to guide the price setting process and yet be interactively editable.

For the typical business, the above systems are still too inaccurate, unreliable, costly and intractable in order to be utilized effectively for price setting. Businesses, particularly those involving large product sets, would benefit greatly from the ability to have accurate and efficient price setting tools available that allows for instant simulations and interactivity of pricing scenarios.

It is therefore apparent that an urgent need exists for an improved system and method for price setting and optimization that is both accurate and efficient. This solution would replace price setting techniques with a more helpful system; thereby increasing the realization of business goals, standardization of deal negotiations and decreased waste.

### SUMMARY OF THE INVENTION

To achieve the foregoing and in accordance with the present invention, a method and system for Price Setting and Optimization are provided. Such a system is useful for a business to set product prices in order to effectuate business goals. Such an analysis may be utilized by the business for price management.

The instant systems allow sales managers and other client users to set optimal price points at any level or dimension of the business across including products, customers, customer segments and geography. Selected parameters may be set while the remaining terms are optimized to give a desired result.

The instant invention enables a business user to select a preferred business segment for analysis. The user may adjust selected prices as desired. As prices are adjusted, the resulting business impact is simulated in real time. Users may simulate price, revenue, margin and win ration impact at any level and dimension of the selected business segment.

The pricing tool utilizes a multi-dimensional workbook which allows the business user to specify a worksheet corresponding to a desired business segment (e.g. product hierarchy, geography, industry and/or sales channel). Worksheets are used to analyze historical price and sales data, edit desired price points and view simulated results—all in one worksheet. The pricing tool allows the user to set or edit parameters (e.g. target prices, or approval prices) at any level of the business and inherited down throughout the worksheet, e.g. a price change applied at a product family gets inherited down to each product belonging to the product family. Optimization and analytical tools may then be used to analyze the effects of changed parameters at any level of the worksheet. Edited parameters are incorporated into the optimization and analysis at all levels.

The pricing tool incorporates a price triangulation module which may be used to balance results of the optimization with additional analysis to arrive at final prices. An effective business to business price setting tool must allow the business user to create a useful business segmentation structure and to incorporate pricing goals and constraints into the overall process. The instant price triangulation module incorporates business goals and constraints into the price setting process.

Optimization may be performed at any selected segment and for any level or dimension of said segment. Business goals and constraints are incorporated into all dimensions and levels of the workbook.

The invention allows the user to set up a novel workspace whereby prices and policies may be set on worksheets at any level or dimension of the business hierarchies (e.g., product, customer, and organization).

These and other features of the present invention will be described in more detail below in the detailed description of the invention and in conjunction with the following figures.

### BRIEF DESCRIPTION OF THE DRAWINGS

In order that the present invention may be more clearly ascertained, one embodiment will now be described, by way of example, with reference to the accompanying drawings, in which:

FIG. 1 shows a block diagram illustrating the price setting and optimization system in accordance with an embodiment of the present invention;

FIG. 2 shows a block diagram illustrating the optimization and triangulation system for the price setting and optimization system of FIG. 1;

FIG. 3 shows a block diagram illustrating the manager module for the price setting and optimization system of FIG. 1;

FIG. 4 shows a flow chart illustrating the process of price setting for the price setting and optimization system of FIG. 1;

FIG. 5 shows a flow chart illustrating the process of planning business goals for the price setting and optimization system of FIG. 1;

FIG. 6 shows a flow chart illustrating the process of optimization for the price setting and optimization system of FIG. 1;

FIG. 7 shows a flow chart illustrating the process of receiving optimization input for the price setting and optimization system of FIG. 1;

FIG. 8 shows a flow chart illustrating the process of price optimization for the price setting and optimization system of FIG. 1;

FIG. 9 shows a flow chart illustrating the process of triangulating pricing for the price setting and optimization system of FIG. 1;

FIG. 10 shows a flow chart illustrating the process of managing goals for the price setting and optimization system of FIG. 1;

FIG. 11 shows a flow chart illustrating the process of generating product pricing for the price setting and optimization system of FIG. 1;

FIG. 12 shows a flow chart illustrating the process of generating market pricing for the price setting and optimization system of FIG. 1;

FIG. 13 shows a flow chart illustrating the process of generating channel pricing for the price setting and optimization system of FIG. 1;

FIG. 14 shows a flow chart illustrating the process of setting channel prices for the price setting and optimization system of FIG. 1;

FIG. 15 shows a flow chart illustrating the process of generating consumer pricing for the price setting and optimization system of FIG. 1;

FIG. 16 shows a flow chart illustrating the process of generating deal terms for the price setting and optimization system of FIG. 1;

FIG. 17 shows a flow chart illustrating the process of pricing execution for the price setting and optimization system of FIG. 1;

FIG. 18 shows a flow chart illustrating the process of performance tracking for the price setting and optimization system of FIG. 1;

FIG. 19 shows a price waterfall diagram illustrating the management of pricing in an implementation of the price setting and optimization system of FIG. 1;

FIG. 20 shows a worksheet interface implementing the price setting and optimization system of FIG. 1;

FIG. 21 shows a triangulation diagram generated by an implementation of the price setting and optimization system of FIG. 1;

FIG. 22A illustrates a computer system, which forms part of a network and is suitable for implementing the price setting and optimization system of FIG. 1;

FIG. 22B illustrates a block diagram of a computer system and network suitable for implementing price setting and optimization system of FIG. 1.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

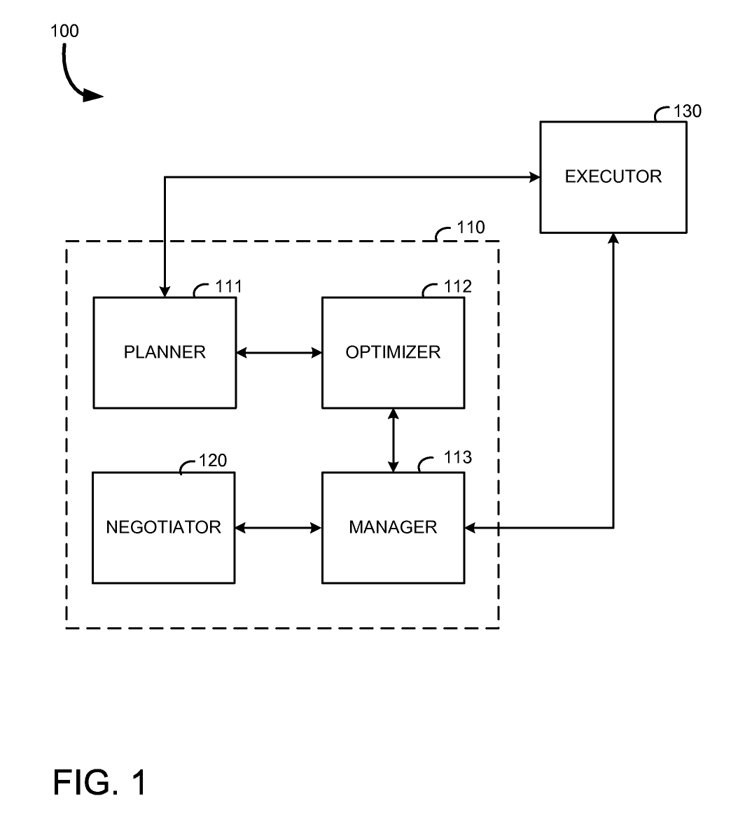

To facilitate discussion, FIG. 1 shows a block diagram illustrating the Price Setting and Optimization System 100 in accordance with an embodiment of the present invention. The instant systems allow sales managers and other client users to change and optimize selected parameters at any level or dimension of the price setting tool. Selected parameters may be set while the remaining terms are optimized to give a desired result.

The instant invention enables a business user to select a preferred business segment for analysis. A business segment can be a combination of one or more of the following dimensions: product group (e.g. product family), geography, industry and sales channel. The user may adjust selected parameters (e.g. list price, target price, approval prices and floor prices) as desired. As parameters are adjusted, the resulting business impact is simulated in real time. Users may simulate price, revenue, profit and margin impact at any level or dimension of the selected business segment.

Price Setting and Optimization System 100 includes a Deal Term Generator 110, coupled to a Negotiator 120 and an Executor 130. Deal Term Generator 110 includes a Planner 111, Optimizer 112, and Deal Manager 113. Deal Term Generator 110 receives business goals, and feedback from performance tracking. Deal Term Generator 110 is enabled to generate business to business price setting. Price setting may include suggesting deal terms and product pricing, channel pricing, market pricing and customer pricing.

Planner 111 provides for the setting of business goals. These business goals are then tied to pricing actions. Planner 111 receives feedback information from Executor 130. Additionally, Planner 111 may provide elasticity models. The Planner 111 may be coupled to Optimizer 112. Planner 111 provides Optimizer 112 with pricing actions, pricing constraints, statistical information, and elasticity models. It should be noted that the elasticity modeling utilized by Price Setting and Optimization System 100 is purposeful left unspecified such that various models may be utilized as needs dictate. For example, in some embodiments linear programming may be utilized. Alternatively, in some embodiments Bayesian shrinkage modeling may be utilized. Alternate modeling may be utilized as is well known by those skilled in the art. In some embodiments, rule or constraint based optimization may be utilized rather than elasticity based optimization.

Optimizer 112 provides optimization of the pricing and deal terms by applying the modeling to the pricing constraints, as provided by Planner 111. In some embodiments, Optimizer 112 may include industry standard values for variables and constraints, such as price sensitivity and product attributes. Additionally, in some embodiments these industry standards may be modified by the user to reflect business knowledge. One advantage of the present invention is that it utilizes standard business knowledge, thereby providing more closely tailored pricing optimizations to business realities. Additional mathematical or specialized knowledge is not required for effective price setting that confirms to specific business goals.

Optimizer 112 may, in some embodiments, be coupled to Manager 113. Manager 113 provides the generation of list prices and deal terms (target prices, approval prices and floor prices). Manager 113 utilizes the optimized price outputs of Optimizer 112 in order to provide generate the optimal prices and deal term suggestions. These deal term suggestions may then be output to Negotiator 120 in order to facilitate negotiations and pricing at various stages of business to business interactions. Additionally, Negotiator 120 may incorporate approval routing and alerts triggered by deal terms (e.g. a negotiated price which is below the approval price level or floor price). In some embodiments Manager 113 may provide output in multiple formats in order to further facilitate deal negotiations. Such outputs may include pricing waterfall diagrams, charts, spreadsheet outputs, or any output beneficial for business use, as is well known by those skilled in the art.

In some embodiments, Manager 113 may be enabled to provide “what if” scenarios to the user. In these circumstances, possible scenarios may be input into Planner 111. Then Manager 113 may provide likely results of these possible scenarios. In this way, potential volatilities of the market or unexpected events may be considered for business to business interactions. This ability has significant repercussions for risk analysis and business planning.

In some embodiments, Negotiator 120 is a sub component of Deal Manager 113. Alternatively, Negotiator 120 may receive output from Deal Manager 113. Negotiator 120 outputs customer specific price quotes, price agreements and/or contracts. In some embodiments Negotiator 120 may be an included automated component of Price Setting and Optimization System 100. In alternate embodiments, Negotiator 120 may be human facilitators who engage in business to business price negotiations. Moreover, in some embodiments Negotiator 120 may be a hybrid system of automated components which provide boiler plate deals and human elements if there are breakdowns of negotiations. The field decisions made by Negotiator 120 are, in some embodiments, driven by the outputs of Manager 113 to ensure profitability, or the optimization of one or more of the business goals set in the Planner 111. Negotiator 120 may additionally present deal guidance to a human agent to facilitate negotiations.

Negotiator 120 may be coupled with Executor 130 to execute the business to business price agreements created. Executor 130 may be an integrated system that ties pricing seamlessly with enterprise pricing systems. In this way, effectuation of pricing is streamlined for enhanced efficiency. Executor 130 may, in some embodiments, provide performance tracking and subsequent feedback to the Deal Term Generator 110, and specifically to the Planner 111. Such performance tracking feedback may be utilized by Planner 111 to statistically modify the modeling to provide increased accuracy of subsequent price settings.

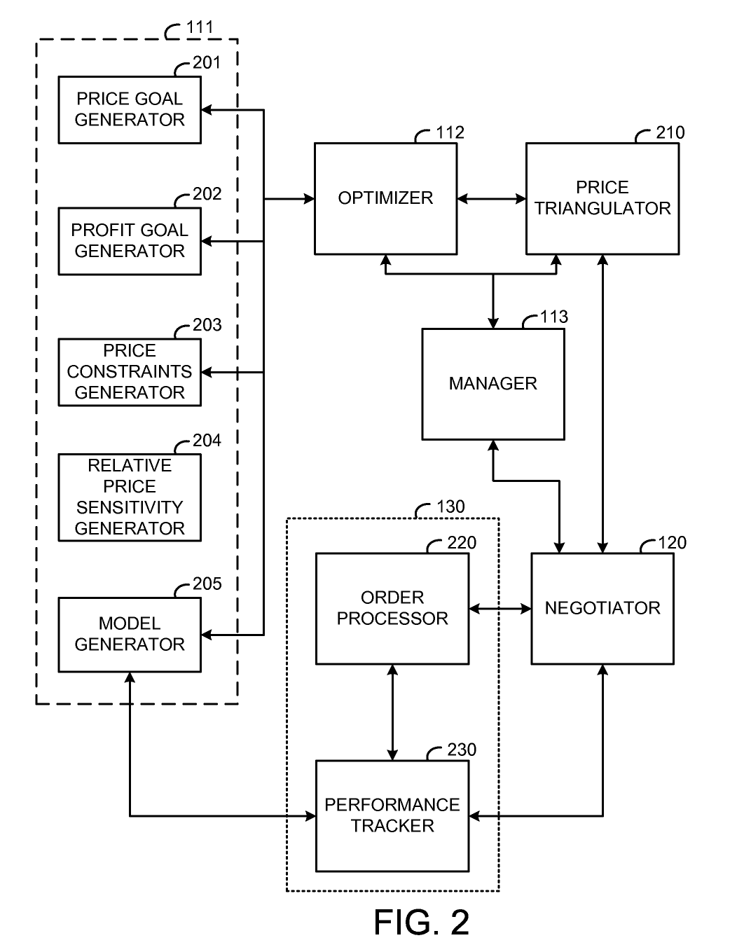

FIG. 2 shows a block diagram illustrating the optimization and triangulation system for the price setting and optimization system of FIG. 1. In some embodiments, the Optimizer 112 receives input from Price Goal Generator 201, Profit Goal Generator 202, Price Constraints Generator 203, Relative Price Sensitivity Generator 204 and Elasticity Model Generator 205. In some embodiments Price Goal Generator 201, Profit Goal Generator 202, Price Constraints Generator 203, Relative Price Sensitivity Generator 204 and Elasticity Model Generator 205 are components of the Planner 111. The Optimizer 112 may utilize the received information in order to generate optimized prices as well as estimations of volume impact, revenue impact and profit impact. In some embodiments, Optimizer 112 may be coupled to Triangulator 210 and Manager 113.

Triangulator 210 may be enabled to analyze the pricing information generated by Optimizer 112. Triangulator 210 may then generate list prices, target prices, approval prices and floor prices. Target prices, approval prices and floor prices (also called deal terms) provide guidance for negotiations of business to business deals. Target prices are the desired price for the negotiation. Approval prices are not as high as the target prices, and require approval from management through a workflow system. Approval prices are not automatically approved, but rather trigger approval workflows, where one or more people are required to approve the price before it can be submitted. Floor prices are the minimum prices that may be considered at deal negotiations. The Triangulator 210 may output its information to the Negotiator 120 for deal negotiation guidance. In some embodiments, the Triangulator 210 may provide output to the Manager 113. In such embodiments the Manager 113 may then provide a comprehensive guidance scheme, including pricing recommendations, alerts and policies to the Negotiator 120. Manager 113, as discussed above, may include human actors, automated components, or a combination of both human and machine actors.

The results from Negotiator 120 (e.g. customer quotes, price agreements and/or contracts) may be then output to Order Processor 220 and Performance Tracker 230. Order Processor 220 and Performance Tracker 230 are components of Executor 130 in some embodiments. Order Processor 220 may be enabled to streamline downstream processes of packaging, invoicing and additional standard order processes as is well known to those skilled in the art. Performance Tracker 230 tracks performance and provides feedback for the tracked performance. In some embodiments, Performance Tracker 230 may receive information from Negotiator 120 and Order Processor 220 in order to compile performance tracking data.

Results from Performance Tracker 230 may then be output to Elasticity Model Generator 205 for tuning of the elasticity models in order to generate tailored and accurate elasticity models. Such modification of models may include linear adjustments or statistical methods of modification.

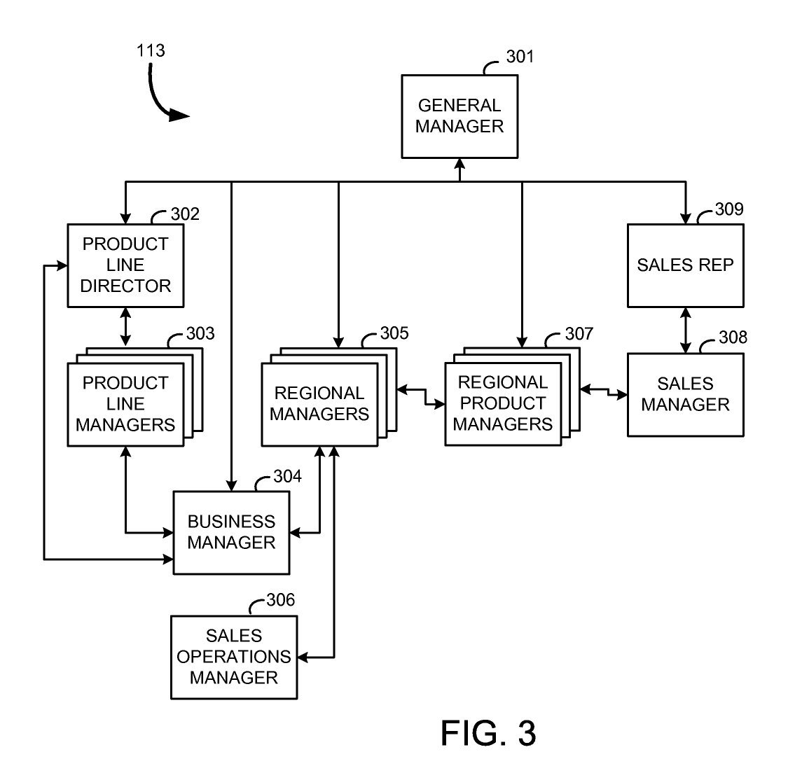

FIG. 3 shows a block diagram illustrating the pricing factors of the Manager 113 for the Price Setting and Optimization System 100 of FIG. 1. Manager 113 provides management of pricing for every level of business to business price setting processes. The components of FIG. 3 provide pricing factors for optimization by Price Setting and Optimization System 100. However, the pricing factors as detailed in FIG. 3 are exemplary in nature. Individual businesses will have unique organizational structures.

A General Manager 301 oversees all other components and may be coupled to Product Line Director 302, Business Manager 304, Regional Managers 305, Product Regional Managers 307 and Sales Representative 309. Product Line Director 302 is coupled to a plurality of Product Line Managers 303 and provides direction of Product Line Managers 303. Product Line Managers 303 manage the various product lines of a particular business. Product Line Managers 303 are coupled to Business Manager 304, which provides oversight of Product Line Managers 303 and Regional Managers 305.

The plurality of Regional Managers 305, each provide regional management. Regional Managers 305 receive direction from Sales Operation Manager 306. Sales Operation Manager 306 manages the sales operation for the business. The plurality of Product Regional Managers 307 manage the products of each region. Said management includes directing of Sales Manager 308. Likewise Sales Manager 308 provides oversight of Sales Representative 309. Ultimately, a vast plethora of pricing factors are generated by the components of FIG. 3. Each pricing factor may be arranged into a pricing waterfall in order to illustrate the bearing these factors have upon the optimized price setting.

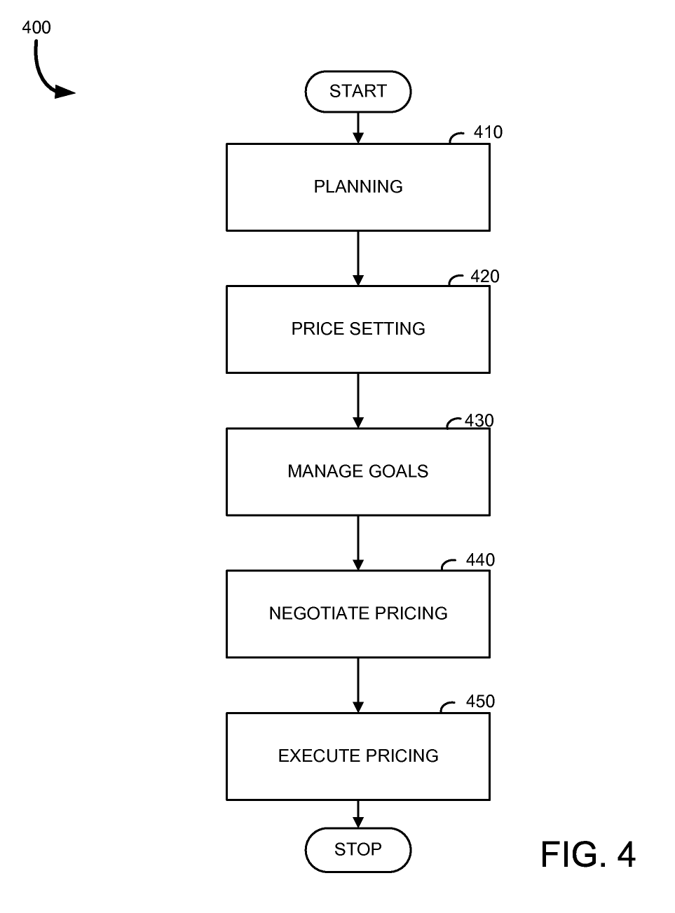

FIG. 4 shows a flow chart illustrating the process of price setting, shown generally at 400, for the price setting and optimization system of FIG. 1. The process begins at the planning step 410, where business goals and pricing actions are planned. This step may, in some embodiments, occur within Planner 111. For step 410, standard business goals may be included, such as maximization of profits; however, additional goals may be included as is deemed necessary. Such goals may include a certain sales volume, certain revenue, a change in market share or any additional desired business goal. Additionally, Step 410 may include planning goal constraints, such as a sales constraint for an inventory deficient product. Moreover, in some embodiments, business knowledge may be included at step 410 in order to provide more efficient price setting.

Next, at step 420, price setting occurs. This step may be performed at Optimizer 112. Alternatively, in some embodiments step 420 may be performed in Optimizer 112 and Triangulator 210. At step 420, optimized pricing and triangulation occurs in order to set the prices.

Then, at step 430, goals are managed. This step occurs at the Manager 113. The managed goals are then output to Negotiator 120 for negotiation at step 440. Then at step 450, pricing is executed at the Executor 130. The process then ends.

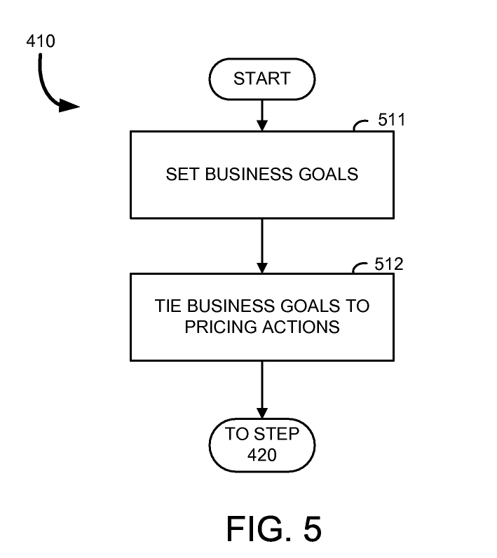

FIG. 5 shows a flow chart illustrating the process of planning, where planning includes the planning of business goals for the price setting and optimization system of FIG. 1, shown generally at step 410. This process begins at step 511, where business goals are set. As previously discussed, the business goals may include business standards and may be modified as needed to meet any desired result. Then, at step 512, the business goals set at step 511 are tied to pricing actions. The process then ends by proceeding to step 420 of FIG. 4.

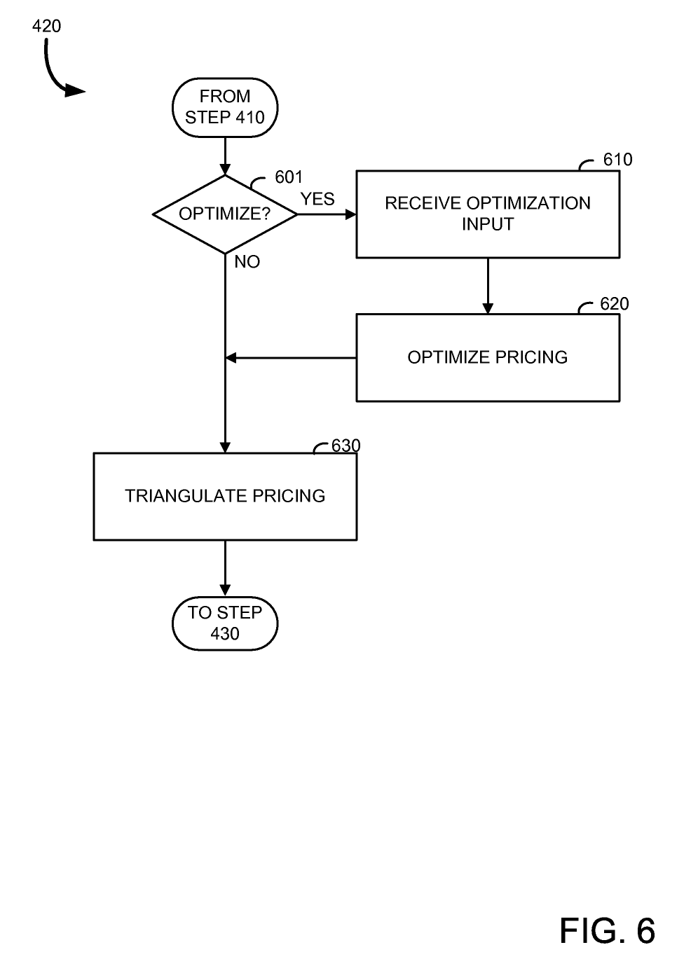

FIG. 6 shows a flow chart illustrating the process of price setting for the price setting and optimization system of FIG. 1, shown generally at 420. The process begins from step 410. The process then progresses to step 601, where a decision is made whether to optimize. Triangulation is independent of but complementary to optimization. Optimization does not have to be run in order to use Triangulation. However, if optimization is performed, then triangulation is a very useful way of setting the best price that balances the optimal price as determined by a set of assumptions and constraints with other relevant data points such as competitive prices. If Optimization is desired then the process proceeds to step 610 where optimization input is received. Optimization input is received from Planner 111 as the result of the process illustrated at step 410. Additional optimization input may be received from components Triangulator 210, Profit Goal Generator 202, Price Constraints Generator 203, Relative Price Sensitivity Generator 204 and Elasticity Model Generator 205. Triangulator 210, Profit Goal Generator 202, Price Constraints Generator 203, Relative Price Sensitivity Generator 204 and Elasticity Model Generator 205 may provide industry standards, and in some embodiments may be modified by user's business knowledge for enhanced accuracy.

Then, at step 620, prices are optimized by utilizing the optimization input received from step 610. Optimization, as previously discussed, may utilize performance feedback as well as elasticity modeling and business goals and constraints in order to yield optimum pricing. In some embodiments, optimization may be rule based instead of elasticity based.

These optimums, at step 630, may then be triangulated in order to yield business to business deal suggestions for enhanced negotiations. Triangulation of prices may occur at the Triangulator 210. In some embodiments, triangulation may include user defined constraints, and rules. For example, in some embodiments, the user may define the target price to be a minimum of 10% greater than variable costs, but not more than 75% of the historical pricing. In such a way the Triangulator 210 may compile all rules and optimize pricing according to the business goals to generate triangulated pricing. In some embodiments the Triangulator 210 may provide an integrated display of optimizations, sales history and constraints in order to provide a context rich backdrop for the user to define the floor, approval and target pricing. The process then ends by proceeding to step 430 of FIG. 4.

If at step 601 optimization is not desired the process goes directly to step 630 where triangulation is performed. As discussed above triangulation of prices may occur at the Triangulator 210. In some embodiments, triangulation may include user defined constraints, and rules. For example, in some embodiments, the user may define the target price to be a minimum of 10% greater than variable costs, but not more than 75% of the historical pricing. In such a way the Triangulator 210 may compile all rules and optimize pricing according to the business goals to generate triangulated pricing. In some embodiments the Triangulator 210 may provide an integrated display of optimizations, sales history and constraints in order to provide a context rich backdrop for the user to define the floor, approval and target pricing. The process then ends by proceeding to step 430 of FIG. 4.

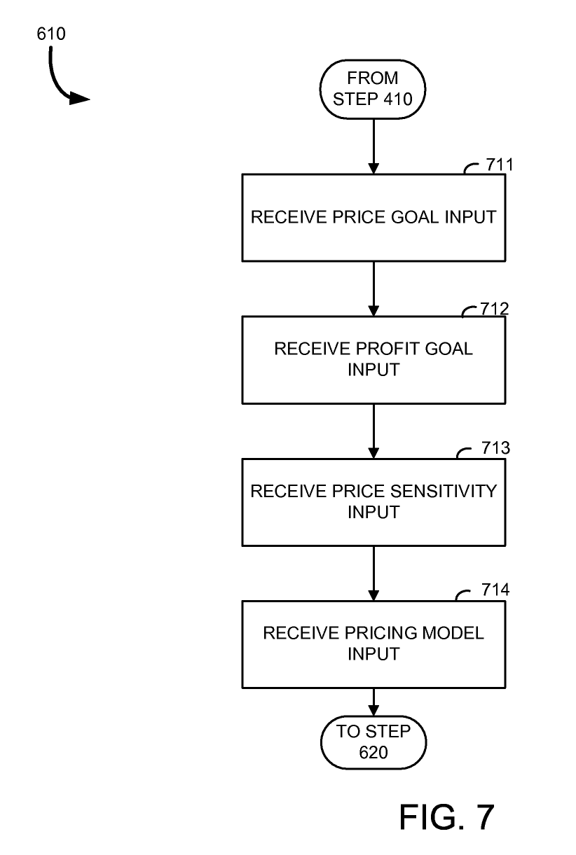

FIG. 7 shows a flow chart illustrating the process of receiving optimization input for the price setting and optimization system of FIG. 1, shown generally at 610. The process begins at step 711 where price goals are inputted. Price goals may exist to conform to competitor pricing, promotional advertised pricing, manufacturer demands, or for any other reason.

Then at step 712, profit goals may be inputted. Typically profits are maximized for. However, in some circumstances businesses may require other goals to take precedence over profit, such as expanding market dominance through increased volume sales. In such circumstances the business may desire that some base level of profit be maintained to support the business and appease investors'; however some profit may be willingly sacrificed in favor of dominating the marketplace. Thus the present invention allows for powerful, strategic business price management.

At step 713, price sensitivity is inputted. Business to business customers may have varying sensitivity to pricing for various products. In some embodiments, the price of the product may be linearly correlated with price sensitivity. Also, in some embodiments, type of product may play a substantial role in price sensitivity. Statistically or empirically derived standard price sensitivity may be provided. Additionally, in some embodiments, the user may be able to modify these price sensitivity values utilizing business knowledge. Moreover, in some embodiments, these price sensitivity values may be unique within every negotiation. This is due to inconsistency of price perception from one consumer to another. As such the present invention, in some embodiments, may be enabled to have variable price sensitivities dependent upon customers.

Then in step 714, pricing models are input. Models may be elasticity models or alternate models, such as rule based. In some embodiments, the user may select the model to be used by the Optimizer 112. In some embodiments, a default model may be provided. Additionally, in some embodiments, when performance tracking data is received, the model may be modified to better fit actual performance. Such modifications may be statistical in nature, however any suitable method may be utilized as is well known in the art. Moreover, in some embodiments, model selection may be automated by the Deal Term Generator 110. In these embodiments the model may be chosen as to provide best-fit to the received performance tracking feedback. Alternatively, models may be selected in response to product types sold, region, economic climate, or any multitude of variables which provide for accurate modeling selection. The process then ends by proceeding to step 620 of FIG. 6.

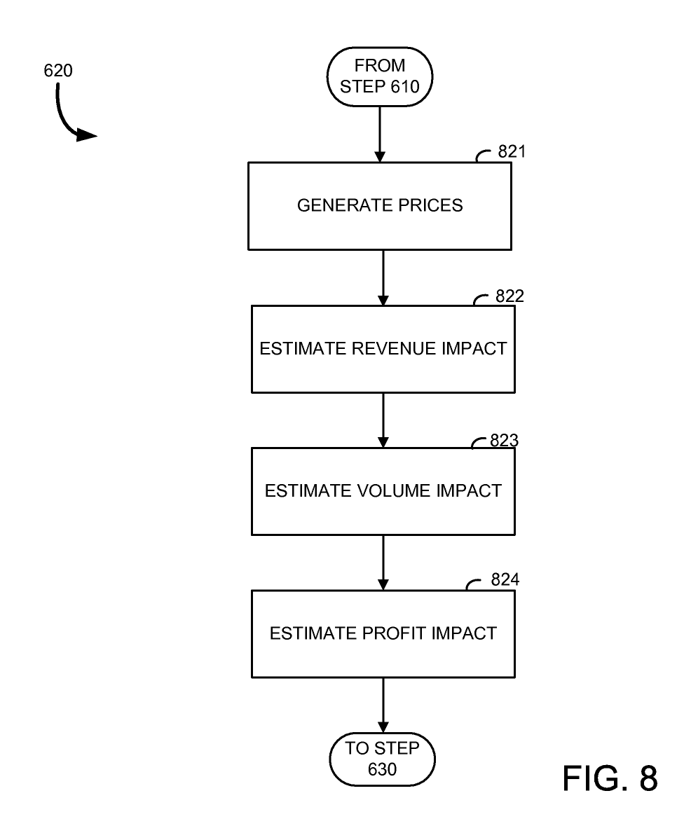

FIG. 8 shows a flow chart illustrating the process of price optimization for the price setting and optimization system of FIG. 1, shown at 620. The process begins from process 610 of FIG. 6. Then the process continues at step 821 where the optimized prices are generated. The price generation is performed by the Optimizer 112, and utilizes the inputted optimization information from process 610.

Then, at step 822, an estimation is generated for the impact that the optimized prices will have upon revenue by utilizing the inputted optimization data. At step 823 an estimation is generated for the impact that the optimized prices will have upon product sales volume by utilizing the inputted optimization data. At step 824 an estimation is generated for the impact that the optimized prices will have upon profit by utilizing the inputted optimization data. It should be noted that steps 822, 823 and 824 may be performed in parallel or any order.

The data generated from steps 822, 823 and 824 may be useful for business planning and production planning. Additionally, this data may be important for the compliance with defined constraints and goals inputted at process 610. After steps 822, 823 and 824 have all completed the process ends by proceeding to step 630 of FIG. 6.

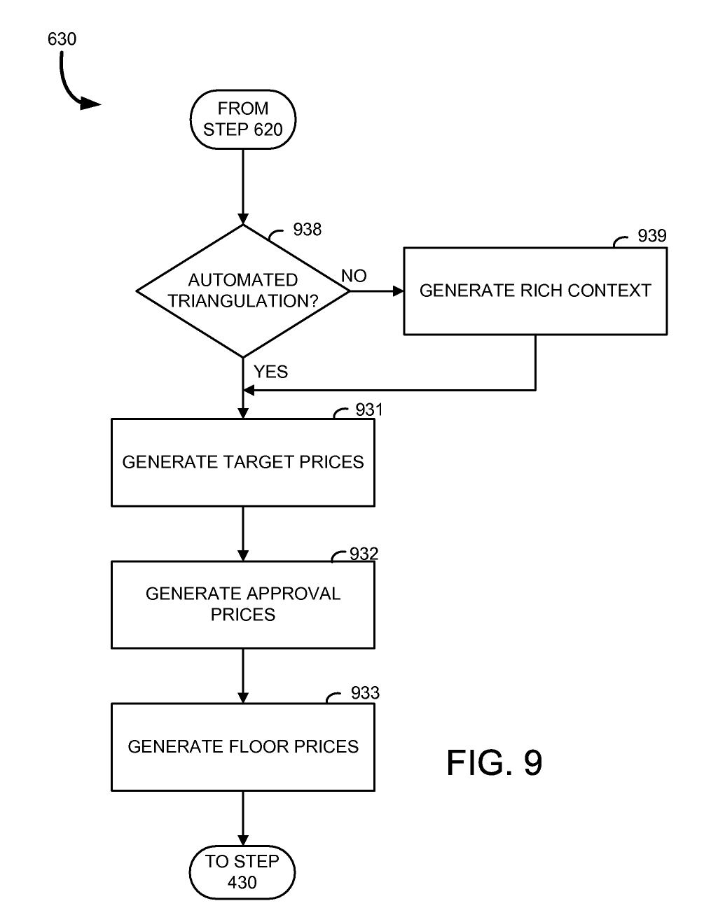

FIG. 9 shows a flow chart illustrating the process of triangulating pricing for the price setting and optimization system of FIG. 1, shown at 630. The process begins from process 620 at FIG. 6. Then at step 938 an inquiry is made whether the triangulation is to be performed in an automated fashion. If so then, at step 931, target prices are generated. At step 932 approval prices are generated. At step 933 floor prices are generated. In some embodiments, Steps 931, 932 and 933 are performed in parallel. The generation of floor, approved and target pricing may be effectuated by statistical optimization methods. Alternatively, in some embodiments, the generation of the prices may be based upon a rule based constraint scheme. After target, approval and floor prices are generated the process end by proceeding to step 430 of FIG. 4.

Else, if at step 938 the triangulation is not automated, then the process proceeds to step 939 where a context rich interface is generated for the user to effectuate the price settings. Then, at step 931, target prices are generated. At step 932 approval prices are generated. At step 933 floor prices are generated. In these embodiments the Triangulator 210 provides an interface for the user where multiple sources of relevant data are displayed, thereby creating the context rich environment for the price setting. This environment may include the optimized price, historical price, constraint data, win probability, active contracts, and additional information as is beneficial for effectuating the price generation. After target, approval and floor prices are generated the process ends by proceeding to step 430 of FIG. 4.

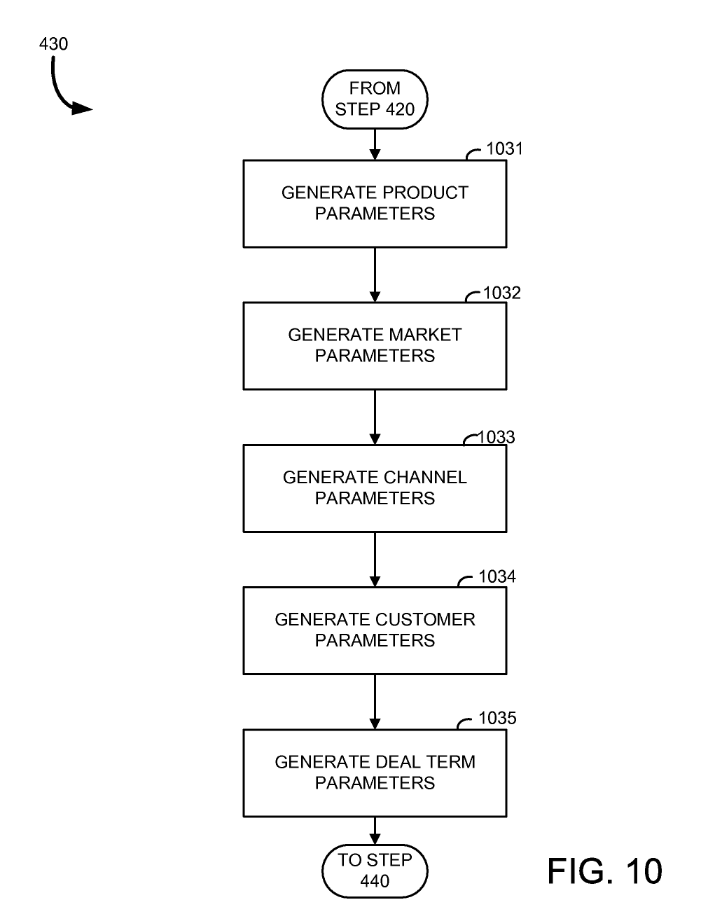

FIG. 10 shows a flow chart illustrating the process of managing goals for the price setting and optimization system of FIG. 1, shown at 430. The process begins from process 420 from FIG. 4. Then, at step 1031, product parameters are generated. At step 1032 market parameters are generated. At step 1033 channel parameters are generated. At step 1034 customer parameters are generated. Lastly, at step 1035 the deal term parameters are generated. In this fashion the price waterfall may be constructed for each pricing element. Additionally, these price settings may be utilized to create comprehensive deal suggestions for the Negotiator 120. The process end by progressing to step 440 of FIG. 4.

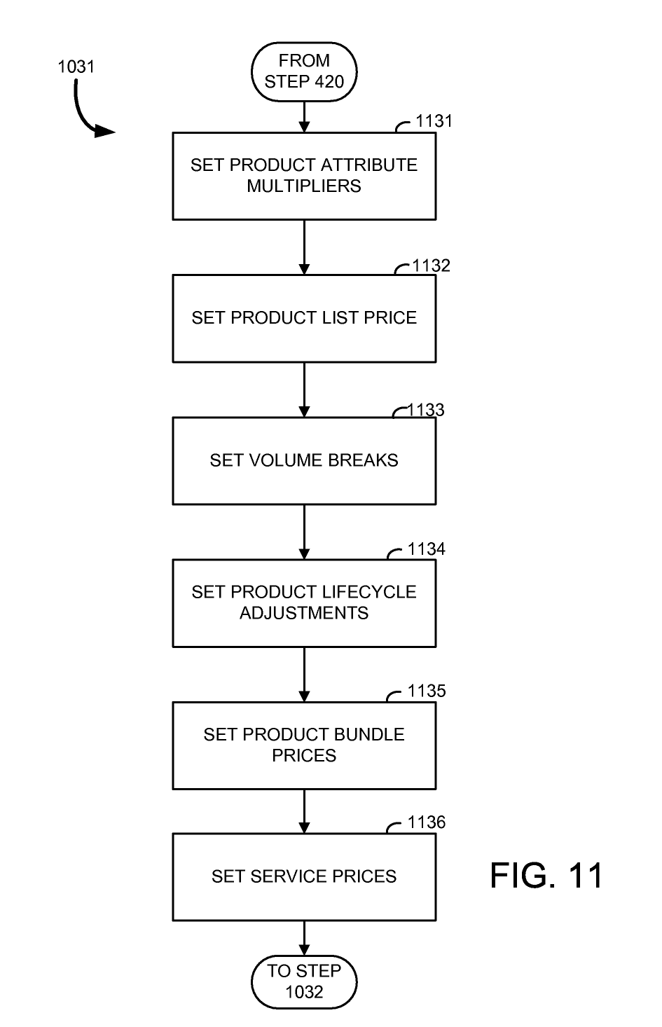

FIG. 11 shows a flow chart illustrating the process of generating product parameters for the price setting and optimization system of FIG. 1, shown at 1031. The process 1031 as illustrated is intended as exemplary; individual businesses will vary in the process of generating product parameters for the price setting and optimization system. This process begins from step 420 of FIG. 4. Then at step 1131 product attribute multipliers are set. At step 1132 product list prices are set. At step 1133 product volume breaks are set. At step 1134 product lifecycle adjustments are set. At step 1135 product bundle prices are set. At step 1136 service prices are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 1032 of FIG. 10.

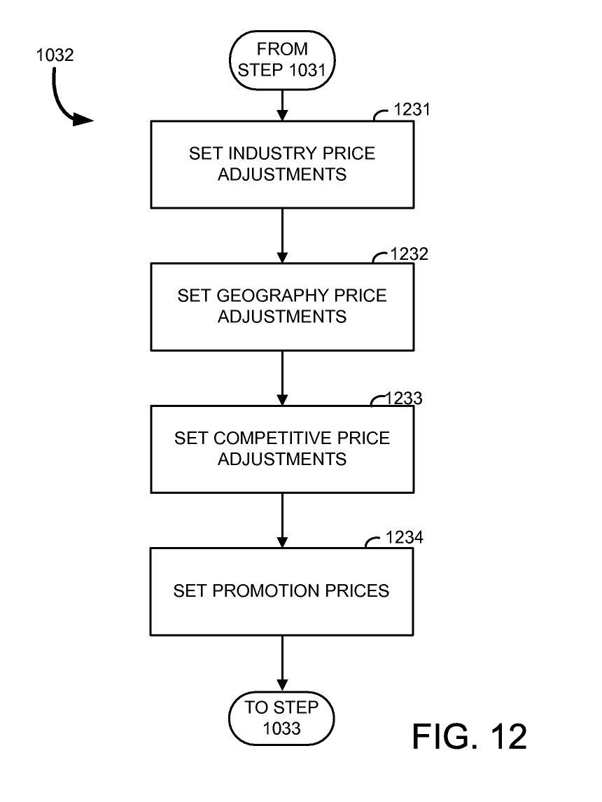

FIG. 12 shows a flow chart illustrating the process of generating market parameters for the price setting and optimization system of FIG. 1, shown at 1032. The process 1032 as illustrated is intended as exemplary; individual businesses will vary in the process of generating market parameters for the price setting and optimization system. The process begins from step 1031 of FIG. 10. At step 1231 industry price adjustments are set. At step 1232 geography price adjustments are set. At step 1233 competitive price adjustments are set. At step 1234 promotion prices are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 1033 of FIG. 10.

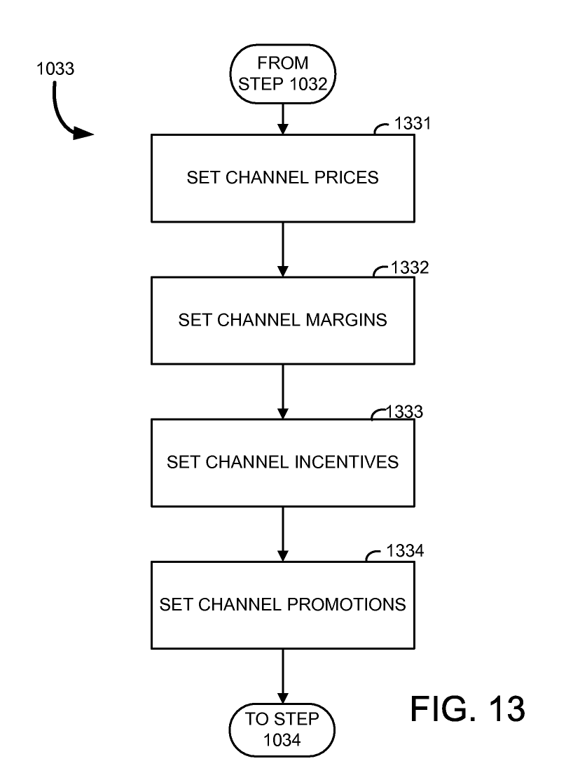

FIG. 13 shows a flow chart illustrating the process of generating channel parameters for the price setting and optimization system of FIG. 1, shown at 1033. The process 1033 as illustrated is intended as exemplary; individual businesses will vary in the process of generating channel parameters for the price setting and optimization system. The process begins from step 1032 of FIG. 10. At step 1331 channel prices are set. At step 1332 channel margins are set. At step 1333 channel incentives are set. At step 1334 channel promotions are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 1034 of FIG. 10.

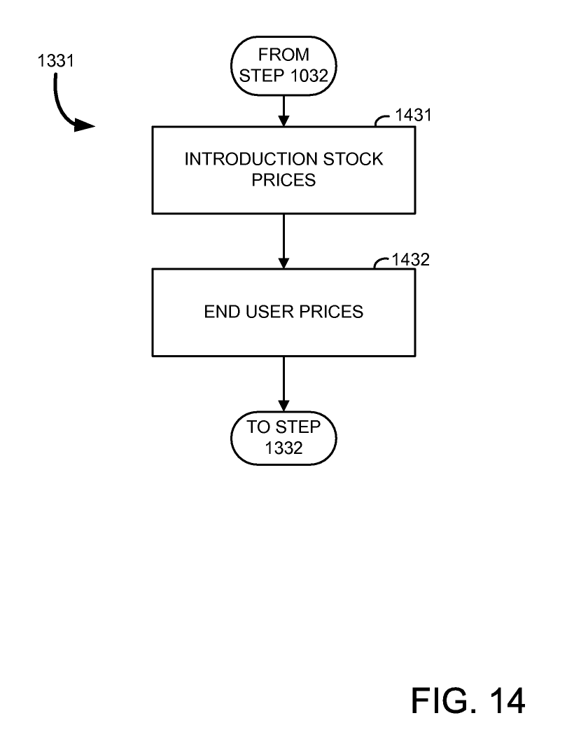

FIG. 14 shows a flow chart illustrating the process of setting channel parameters for the price setting and optimization system of FIG. 1, shown at 1331. The process begins from step 1032 of FIG. 10. At step 1431 introductory stock prices are set. At step 1432 end user prices are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 1032 of FIG. 10.

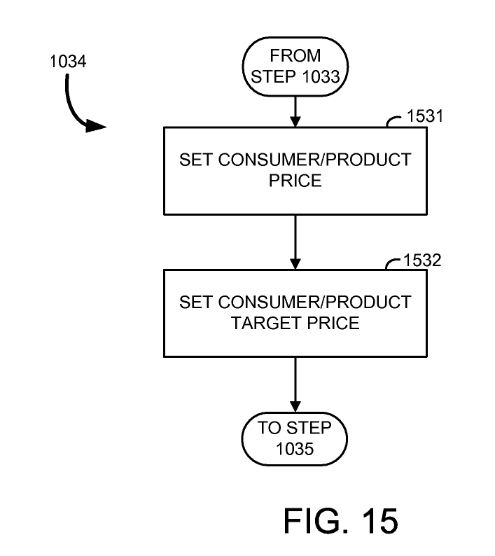

FIG. 15 shows a flow chart illustrating the process of generating consumer parameters for the price setting and optimization system of FIG. 1, shown at 1034. The process 1034 as illustrated is intended as exemplary; individual businesses will vary in the process of generating consumer parameters for the price setting and optimization system. The process begins from step 1033 of FIG. 10. At step 1531 product/consumer prices are set. At step 1532 product/consumer target prices are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 1035 of FIG. 10.

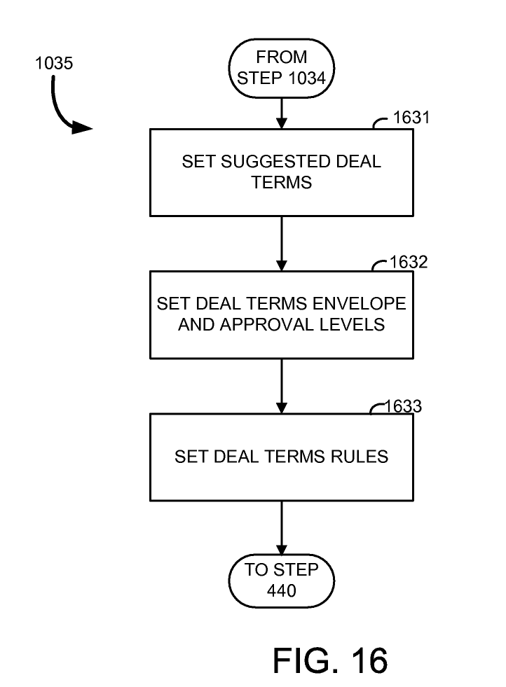

FIG. 16 shows a flow chart illustrating the process of generating deal term parameters for the price setting and optimization system of FIG. 1, shown at 1035. The process 1035 as illustrated is intended as exemplary; individual businesses will vary in the process of generating deal term parameters for the price setting and optimization system. The process begins from step 1034 of FIG. 10. At step 1631 suggested deal terms are set. At step 1632 deal terms envelope and approval levels are set. The envelope is defined by the floor pricing and the target pricing generated by the Triangulator 210. At step 1633 the deal terms rules are set. Again, these values may be set by automated means by utilizing output from the optimizer, historical data and statistical methods. Also, in some embodiments, the user may configure the set values. Alternatively, in some embodiments, an automated system may set the values and the user may be able to tune the values as is desired. The process then ends by proceeding to step 440 of FIG. 4.

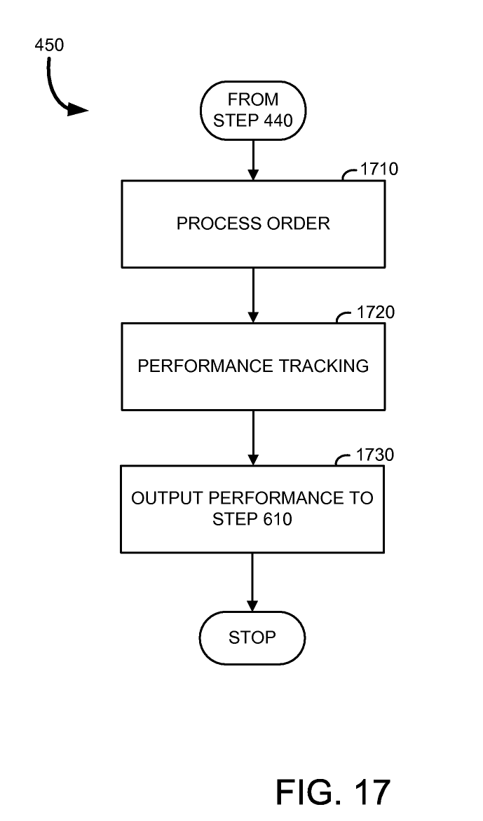

FIG. 17 illustrates a flow chart illustrating the process of executing prices for the price setting and optimization system of FIG. 1, shown at 450. The process begins from step 440 of FIG. 4. At step 1710 orders are processed. Processing orders includes generating invoices, shipping products and the multitude of actions required to complete a typical business order as is well known by those skilled in the art. At step 1720 performance is tracked. Then the results of the performance tracking are outputted to the Planner 111 for further tuning of the elasticity model, at step 1730. The process then ends.

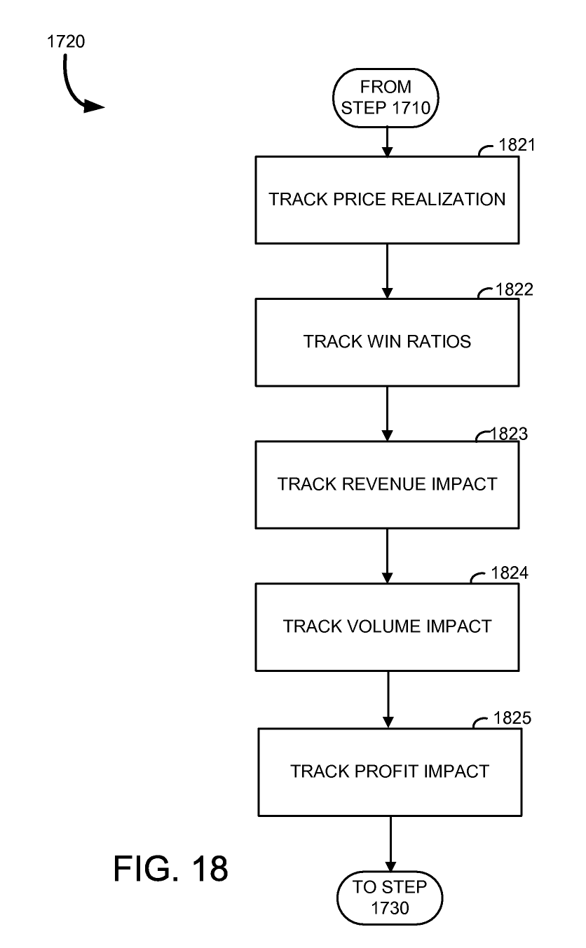

FIG. 18 shows a flow chart illustrating the process of performance tracking for the price setting and optimization system of FIG. 1, shown at 1720. The process begins from step 1710 of FIG. 17. At step 1821 price realization is tracked. At step 1822 win ratios are tracked. Win ratios refer to the percentage of the time the deal negotiations are successful. At step 1823 the impact on revenue is tracked. At step 1824 the impact on volume is tracked. At step 1825 the impact on profit is tracked. The process then ends by progressing to step 1730 of FIG. 17.

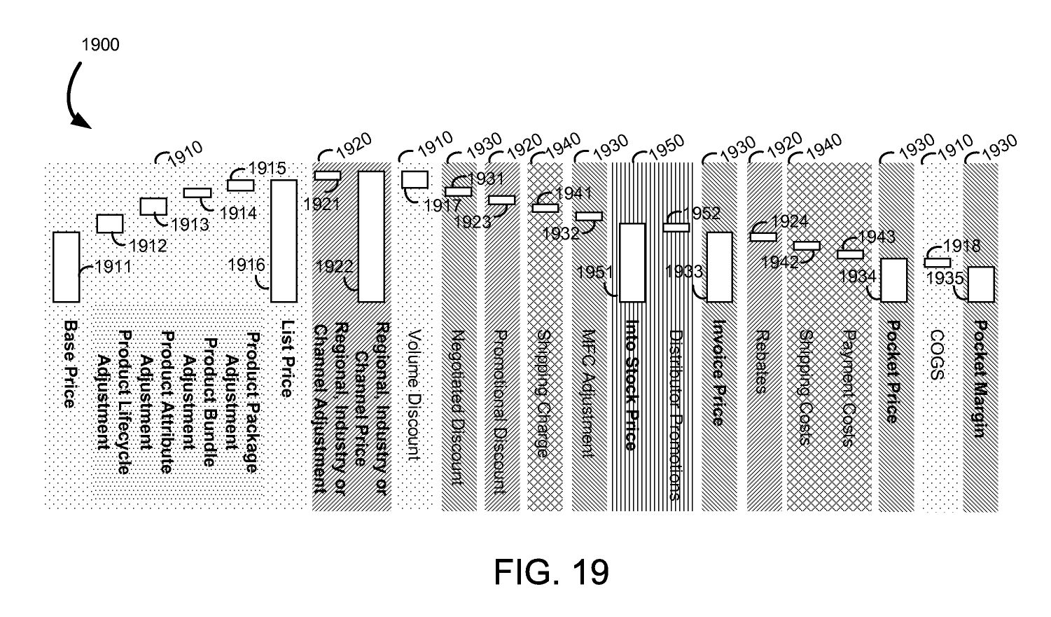

FIG. 19 shows a price Waterfall Diagram 1900 illustrating the management of pricing in an implementation of the price setting and optimization system of FIG. 1. The elements illustrated in Waterfall Diagram 1900 are exemplary; particular waterfall elements may vary dependent upon business. The Price Setting and Optimization System 100 is configured to work with the waterfall defined for the business.

Pricing components found in Product Pricing 1910 include Base Price 1911, Product Lifecycle Adjustment 1912, Product Attribute Adjustment 1913, Product Bundle Adjustment 1914, Product Package Adjustment 1915, List Price 1916, Volume Discount 1917, and COGS 1918. Pricing components found in Market Pricing 1920 include Regional, Industry or Channel Adjustment 1921, Regional, Industry or Channel Price 1922, Promotional Discount 1923, and Rebates 1924. Pricing components found in Negotiated Pricing 1930 include Negotiated Discount 1931, Manufacturers Adjustment 1932, Shipping Charge 1941, Shipping Cost 1942, and Payment Cost 1943, Invoice Price 1933, Pocket Price 1934, and Pocket Margin 1935. Pricing components found in Channel Pricing 1950 include Introductory Stock Price 1951 and Distributor Promotions 1952.

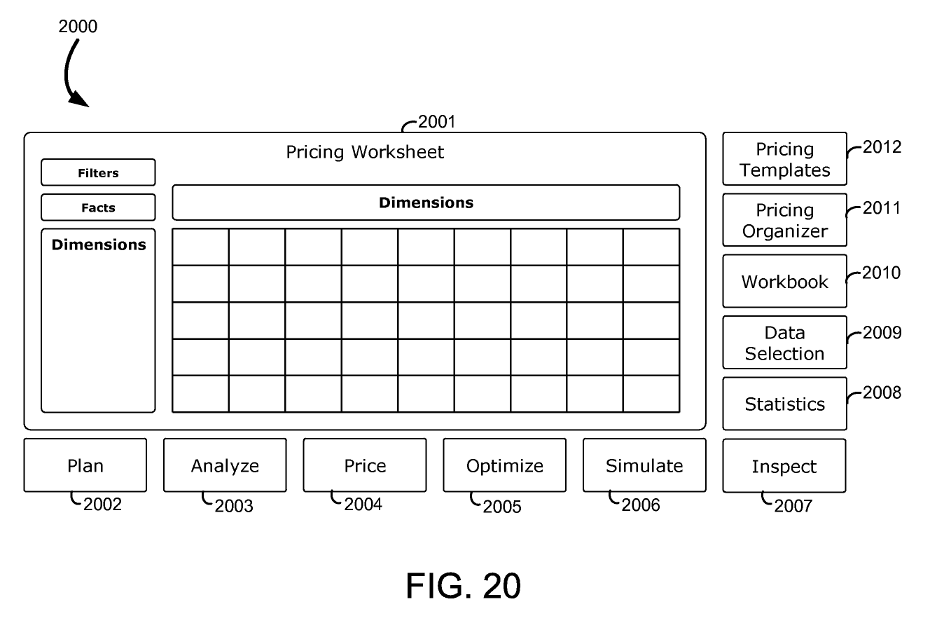

FIG. 20 shows a Worksheet Interface 2000 implementing the price setting and optimization system of FIG. 1. In some embodiments, the present invention is a series of multidimensional spreadsheets. Each spreadsheet is embodied in a Pricing Worksheet 2001. Certain cells in the Pricing Worksheet 2001 may be edited (e.g. list price or deal terms), others are non-alterable (e.g. historical prices or revenue). The present invention enables an editable, multidimensional spreadsheet that may be analyzed while being modified. Additionally, in some embodiments, changes made to the spreadsheet propagate through the spreadsheet to provide this cohabitation of edit ability and analytics.

In some embodiments, all Worksheets 2001 in a given workbook are aware of the edits made to other Worksheets 2001 in the same workbook. Thus, if several different policies that determine the calculation of a price are edited via different Worksheets 2001, the calculation will reflect all of the applicable policy changes made in the workbook.

Moreover, in some embodiments, the modification to the spreadsheet may be enabled to provide instant simulations of alternate scenarios. Such functionality provides a powerful tool to the business user in terms of business planning capability. The present invention thus empowers the user to create highly configured Pricing Worksheet 2001 to suit specific needs and reflect expert business knowledge. Pricing Worksheet 2001 displays and allows configuration of prices and policies, sales analysis, goals and constraints, and cell information of the spreadsheet.

Plan Tab 2002 illustrates a functionality window for displaying and enabling configuration of price constraints, volume constraints and business goals.

Analysis Tab 2003 illustrates a functionality window for displaying and enabling configuration of analysis. Such analysis may be displayed as a bar chart, line chart, min/max chart, trend chart, scatter chart, price brand chart or waterfall chart.

Price Tab 2004 illustrates a functionality window for displaying and enabling configuration of price triangulation and deal guidance.

Optimize Tab 2005 illustrates a functionality window for displaying and enabling configuration of elasticity modeling, business to business price optimization, win probability, average price elasticity optimization and average pricing optimization.

Simulate Tab 2006 illustrates a functionality window for displaying and enabling configuration of simulations of price impact, margin impact and business impact.

Details Tab 2007, labeled inspect, illustrates a functionality window for displaying and enabling configuration of inspection of cells within the spreadsheet, audit trails and comments.

Statistics Tab 2008 illustrates a functionality window for displaying and enabling configuration of statistical analyses, including trending.

Data Selection Tab 2009 illustrates a functionality window for displaying and enabling configuration of price types (list prices, target prices, approval prices, volume discounts or any price adjustments), business dimensions (e.g. product hierarchy, geographies, industries) and business measures. Rows, columns, and/or cells in a Worksheet 2001 may be selected in order to drive other tools, such as charts or mass-edit operations. (e.g. revenue, profit, margin, win ratios).

Workbook Tab 2010 illustrates a functionality window for displaying and enabling configuration of printing and exporting.

Pricing Organizer Tab 2011 illustrates a functionality window for displaying and enabling configuration of approval routing and administration of Pricing Worksheet 2001. In some embodiments, the Organizer 2011 provides a view of workbooks that supports searching and sorting.

Pricing Templates Tab 2012 illustrates a functionality window for displaying and enabling configuration of price templates and industry templates for the Pricing Worksheet 2001.

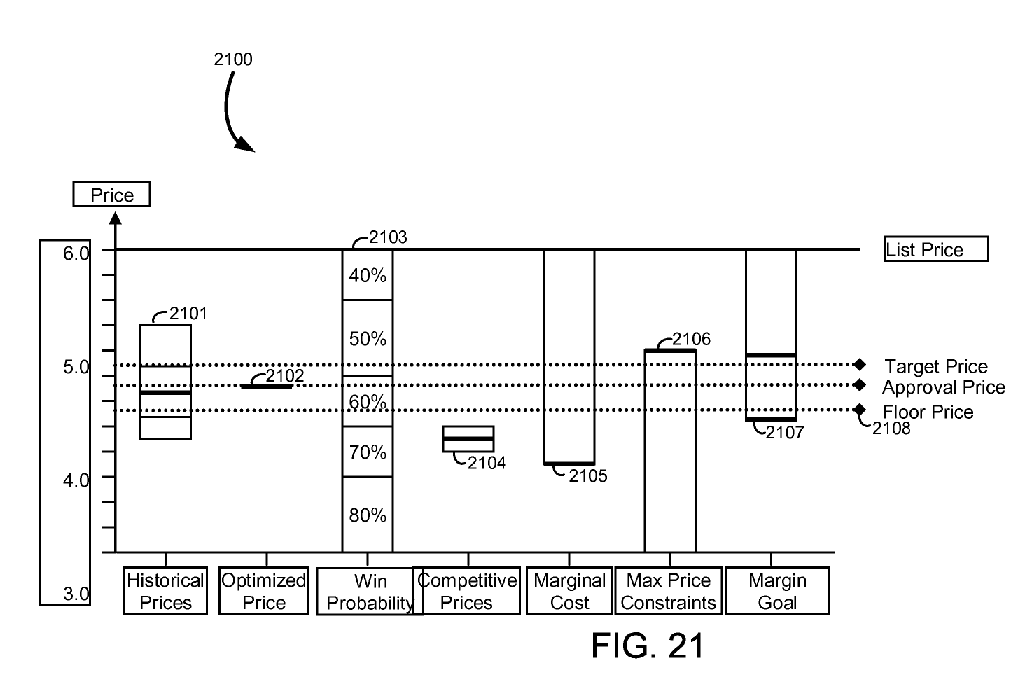

FIG. 21 shows a Triangulation Display 2100 generated by an implementation of the price setting and optimization system of FIG. 1. Historical Pricing 2101 is provided by the performance tracking. Historical Pricing 2101 provides a range of values from highest to lowest price as well as the average or median value. Optimized Price 2102 is generated by the Optimizer 112. Win Probabilities 2103 provides the probability of a successful deal within a price range. Competitors Pricing 2104 provides a comparison to competitor's pricing. Competitors Pricing 2104 provides the maximum, minimum, individual competitive prices as well as the median value. Marginal Cost 2105 provides a basis for the minimum profitable sales price. Pricing lower than Marginal Cost 2105 will be sold at less than cost. Maximum price Constraint 2106 are constraints imposed due to market considerations. Often a business will not want to increase pricing above a pre determined level in order to avoid alienation of customers and for competitive reasons. Margin Goal 2107 is provided by the Optimizer 112 in response to planned goals. Finally, Triangulated Pricing 2108 are the triangulated floor, approval and target pricing for the product.

Triangulation Display 2100 provides a context rich backdrop for setting of floor, approval and target prices by the user. Such a diagram, in conjunction with the user's specialized business knowledge, and the ability to make interactive modifications and analytics simultaneously provides for a powerful business strategy tool.

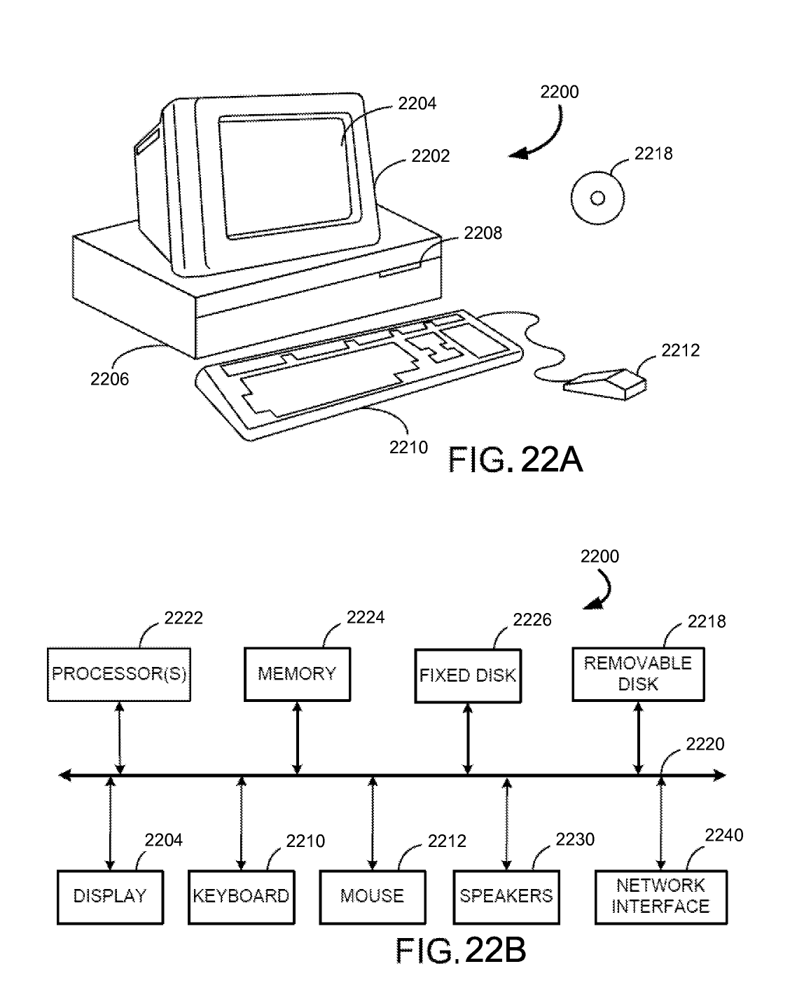

FIGS. 22A and 22B illustrate a Computer System 2200, which is suitable for implementing embodiments of the present invention. FIG. 22A shows one possible physical form of the Computer System 2200. Of course, the Computer System 2200 may have many physical forms ranging from a printed circuit board, an integrated circuit, and a small handheld device up to a huge super computer. Computer system 2200 may include a Monitor 2202, a Display 2204, a Housing 2206, a Disk Drive 2208, a Keyboard 2210, and a Mouse 2212. Disk 2218 is a computer-readable medium used to transfer data to and from Computer System 2200.

FIG. 22B is an example of a block diagram for Computer System 2200. Attached to System Bus 2220 are a wide variety of subsystems. Processor(s) 2222 (also referred to as central processing units, or CPUs) are coupled to storage devices, including Memory 2224. Memory 2224 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2226 may also be coupled bi-directionally to the Processor 2222; it provides additional data storage capacity and may also include any of the computer-readable media described below. Fixed Disk 2226 may be used to store programs, data, and the like and is typically a secondary storage medium (such as a hard disk) that is slower than primary storage. It will be appreciated that the information retained within Fixed Disk 2226 may, in appropriate cases, be incorporated in standard fashion as virtual memory in Memory 2224. Removable Disk 2218 may take the form of any of the computer-readable media described below.

Processor 2222 is also coupled to a variety of input/output devices, such as Display 2204, Keyboard 2210, Mouse 2212 and Speakers 2230. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor 2222 optionally may be coupled to another computer or telecommunications network using Network Interface 2240. With such a Network Interface 2240, it is contemplated that the Processor 2222 might receive information from the network, or might output information to the network in the course of performing the above-described Price Setting and Optimization Price Setting and Optimization System 100. Furthermore, method embodiments of the present invention may execute solely upon Processor 2222 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

Although the present invention has been described in considerable detail with reference to exemplary embodiments, modifications and variations may be made to the disclosed embodiments while remaining within the subject and spirit of the invention. Therefore, the spirit and scope of the appended claims should not be limited to the description of the versions contained herein.

What is claimed is:

1. A method for determining an optimal set of prices or price changes in an integrated price management system, said method comprising:
defining pricing goals and constraints;
selecting a business segment from a group of defined business dimensions; and
generating optimized prices or price changes for said selected business segment.

2. The method of claim 1 further comprising:
generating an aggregate elasticity for said selected business segment; and
generating a demand model using said aggregate elasticity.

3. The method of claim 2 wherein said defined business segments include multiple simultaneous segments.

4. A method of incorporating pricing data into an integrated price management system, said method comprising:
displaying historical price realization data;
displaying price realization goals and constraints;
adjusting price realization goals; and
displaying current price realization data.

5. The method of claim 4 further comprising:
displaying product attribute adjustments;
calculating a list price based on said adjustments; and
displaying the effect of said adjustments on said list price.

6. The method of claim 5 further comprising:
setting volume break information;
displaying historical transactions at each said tier;
calculating a number designating an amount of transactions at each tier; and
graphically displaying the number of transactions at each tier.

7. The method of claim 6 further comprising:
selecting a business segment from a group of defined business dimensions;
displaying price sensitivity data for said business segment;
adjusting said price sensitivity data based on business knowledge; and
generating optimized price changes for said selected business segment.

8. The method of claim 7 further comprising:
displaying historical pricing data for said segment;
displaying selected pricing constraints for said segment;
displaying optimized pricing data for said segment;
displaying competitive pricing data for said segment;
displaying target, approval and floor prices for said segment; and
displaying a deal envelope defined by pricing data.

9. A method of incorporating pricing data into an integrated price management system, said method comprising:
providing a multi-level workspace;
providing a multi-dimensional selector at each level of said workspace;
inputting pricing data parameters;
inputting pricing goals and constraints;
adjusting at least one selected parameter at least one said level and one said dimension of said workspace; and
computing the effect of said at least one adjusted parameter at all levels and dimensions of said workspace.

10. The method of claim 9, further comprising:
generating at least one optimized parameter whereby said optimization comprises:
providing preferred business segmentation;
providing preferred business goals and constraints; and
generating said at least one optimized parameter given said segmentation, goals and constraints.

11. The method of claim 10, further comprising:
displaying historical price realization data;
displaying price realization goals;
adjusting price realization goals; and
displaying current price realization data.

12. The method of claim 11 further comprising:
displaying product attribute adjustments;
calculating a list price based on said adjustments; and
displaying the effect of said adjustments on said list price.

13. The method of claim 12 further comprising:
displaying tiered volume break information;
displaying historical transactions at each said tier;
calculating a number designating an amount of transactions at each tier; and
graphically displaying the number of transactions at each tier.

14. The method of claim 13 further comprising:
selecting a business segment from a group of defined business dimensions;
displaying price sensitivity data for said business segment;
adjusting said price sensitivity data based on business knowledge; and
generating optimized price changes for said selected business segment.

15. The method of claim 14 further comprising:
displaying historical pricing data for said segment;
displaying selected pricing constraints for said segment;
displaying optimized pricing data for said segment;
displaying competitive pricing data for said segment;
displaying target, approval and floor prices for said segment; and
displaying a deal envelope defined by pricing data.
